(19) United States
(12) Patent Application Publication
(10) Pub. No.: US 2014/0049721 A1
(43) Pub. Date: Feb. 20, 2014

(54) Displays with Shielding Layers

(71) Applicants: Chun-Yao Huang, Cupertino, CA (US); Young-Bae Park, San Jose, CA (US); Shih-Chang Chang, Cupertino, CA (US); Szu-Hsien Lee, Cupertino, CA (US)

(72) Inventors: Chun-Yao Huang, Cupertino, CA (US); Young-Bae Park, San Jose, CA (US); Shih-Chang Chang, Cupertino, CA (US); Szu-Hsien Lee, Cupertino, CA (US)

(73) Assignee: Apple Inc., Cupertino, CA (US)

(21) Appl. No.: 13/585,471

(22) Filed: Aug. 14, 2012

(51) Int. Cl. G02F 1/1362

(52) U.S. Cl. CPC G02F 1/136204
USPC 349/59

(57) ABSTRACT

An electronic device may have a display such as a liquid crystal display. The display may have a color filter layer and a thin-film transistor layer. An opaque masking layer may be formed on the color filter layer. An active portion of the display may contain an array of display pixels that are controlled by control signals that are provided over intersecting gate lines and data lines. In an inactive portion of the display, gate driver circuits may be used to generate gate line signals for the gate lines. Portions of the gate lines in the gate driver circuitry, power supply lines, and common electrode lines may be formed on the thin-film-transistor layer. These lines may be electromagnetically shielded using indium tin oxide shielding layers to prevent electric fields from inducing charge in the opaque masking layer and thereby causing color artifacts.

### BACKGROUND

This relates generally to electronic devices and, more particularly, to electronic devices with displays.

Electronic devices such as computers and cellular telephones may have displays. In a typical display such as a liquid crystal display, an array of display pixels is used to display images for a user. Each display pixel may contain an electrode that is used to apply an adjustable electric field to a portion of a liquid crystal layer. The magnitude of the electric field in each pixel controls how much light is allowed to pass through the display to the user.

To provide a display such as a liquid crystal display with the ability to display color images, an array of color filter elements may be aligned with the array of display pixels. A color filter array may contain color filter elements such as red, blue, and green color filter elements that are separated from each other by a patterned black masking layer. Portions of the black masking layer may also be used around the periphery of the color filter array. A typical black masking layer is formed from a resin that has been colored with a black pigment such as carbon black.

The liquid crystal layer in a liquid crystal display is sandwiched between an upper layer such as a color filter layer that includes the color filter array and black masking layer and a lower layer such as a thin-film-transistor layer. The array of electrodes that apply the electric fields to the liquid crystal layer may be arranged in a central rectangular portion of the thin-film-transistor layer. Each of the electrodes may be associated with a respective display pixel that includes thin-film-transistor circuitry. Horizontal gate lines and vertical data lines may be used to apply signals to the display pixels. Gate driver circuits that are formed from thin-film-transistor circuitry on the thin-film-transistor layer may be used to apply gate signals to the gate lines. The gate driver circuits may run along the edges of the central rectangular portion of the thin-film-transistor layer containing the electrodes and other display pixel circuitry.

Electric fields associated with the gate driver circuits and associated conductive lines may give rise to an induced electric charge on the color filter layer. For example, fields from the gate driver circuits may charge the black masking layer on the color filter layer. This charge may give rise to greenish colors, purplish colors, or other colors artifacts in the liquid crystal display during use.

Although inaccurate colors due to induced electric charges in the black masking layer on the color filter can be reduced somewhat by increasing the distance between the gate driver circuitry and the display pixels, this may enlarge the size of the inactive boarder portion of the display.

It would therefore be desirable to be able to provide electronic devices with improved displays such as displays with satisfactory color accuracy and borders that are not overly large.

### SUMMARY

An electronic device may have a display such as a liquid crystal display. The display may have multiple layers of material such as a color filter layer and a thin-film transistor layer. A layer of liquid crystal material may be interposed between the color filter layer and the thin-film transistor layer.

An opaque masking layer may be formed on a display layer such as the color filter layer. The display may have a central active area such as a rectangular active area. An array of display pixels in the active area may present images to a user of the electronic device. Gate lines and data lines may be used to provide control signals to the display pixels.

The active area may be surrounded by an inactive area. For example, the active area may be surrounded by an inactive area that has the shape of a rectangular ring. Thin-film-transistor gate driver circuitry may be located in the inactive area. The gate driver circuitry may be used to generate gate line signals for the gate lines. Portions of the gate lines in the gate driver circuitry, power supply lines, and common electrode lines may be formed on the thin-film-transistor layer in the inactive area. These conductive lines may be electromagnetically shielded using conductive layers such as indium tin oxide shielding layers to prevent electric fields from inducing charge in the opaque masking layer and thereby causing color artifacts.

The shielding layers may be shorted to the common electrode lines. A shielding layer that covers the display pixels may have extended portions that cover the gate driver circuitry and the conductive lines or multiple separate shielding layers may be formed each of which covers different conductive lines and circuitry. For example, a first shielding layer may cover the display pixels and a first common electrode metal line that runs along the edge of the array of display pixels and a second shielding layer that is separated from the first shielding layer by a gap may cover the gate driver circuitry and a second common electrode metal line that runs along the edge of the array of display pixels. The first shielding layer may be shorted to the first common electrode metal line and the second shielding layer may be shorted to the second common electrode metal line.

To reduce capacitive coupling between the lines that are being shielded and the shielding layer, the shielding layer may be provided with an array of openings. A mesh-type shielding layer that is formed in this way may be configured so that the openings overlap gate lines or other conductive lines on the thin-film-transistor layer.

Further features of the invention, its nature and various advantages will be more apparent from the accompanying drawings and the following detailed description of the preferred embodiments.

### BRIEF DESCRIPTION OF THE DRAWINGS

FIG. 1 is a cross-sectional side view of an illustrative display in accordance with an embodiment of the present invention.

FIG. 2 is a top view of an illustrative display of the type shown in FIG. 1 in accordance with an embodiment of the present invention.

FIG. 3 is a cross-sectional side view of an illustrative conductive line that is electrically coupled to a conductive shielding layer in accordance with an embodiment of the present invention.

FIG. 4 is a cross-sectional side view of an illustrative conductive line that is covered with a conductive shielding layer that is isolated from the conductive line by an interposed layer of insulating material in accordance with an embodiment of the present invention.

FIG. 5 is a cross-sectional side view of a display showing how a conductive shielding layer may be configured to cover circuitry such as gate driver circuitry and a common electrode line in accordance with an embodiment of the present invention.

FIG. 6 is a top view of an illustrative display of the type shown in FIG. 5 showing how a conductive shielding layer may be configured to cover circuitry such as gate driver circuitry and a common electrode line in accordance with an embodiment of the present invention.

FIG. 7 is a cross-sectional side view of an illustrative display having segmented conductive shielding layers that are configured to cover circuitry such as gate driver circuitry and a pair of common electrode lines in accordance with an embodiment of the present invention.

FIG. 8 is a top view of a display of the type shown in FIG. 7 that has segmented conductive shielding layers that are configured to cover circuitry such as gate driver circuitry and a pair of common electrode lines in accordance with an embodiment of the present invention.

FIG. 9 is a top view of a portion of a conductive shielding layer having a grid layout with an array of openings that overlap underlying conductive lines to reduce capacitive coupling between the conductive shielding layer and the underlying conductive lines while providing electromagnetic shielding in accordance with an embodiment of the present invention.

FIG. 10 is a cross-sectional side view of a portion of a gate line that is covered with part of the conductive shielding layer material of FIG. 9 in accordance with an embodiment of the present invention.

FIG. 11 is a cross-sectional side view of a portion of a gate line that lies under an opening in the conductive grid of FIG. 9 and that is therefore uncovered by the conductive shielding layer in accordance with an embodiment of the present invention.

### DETAILED DESCRIPTION

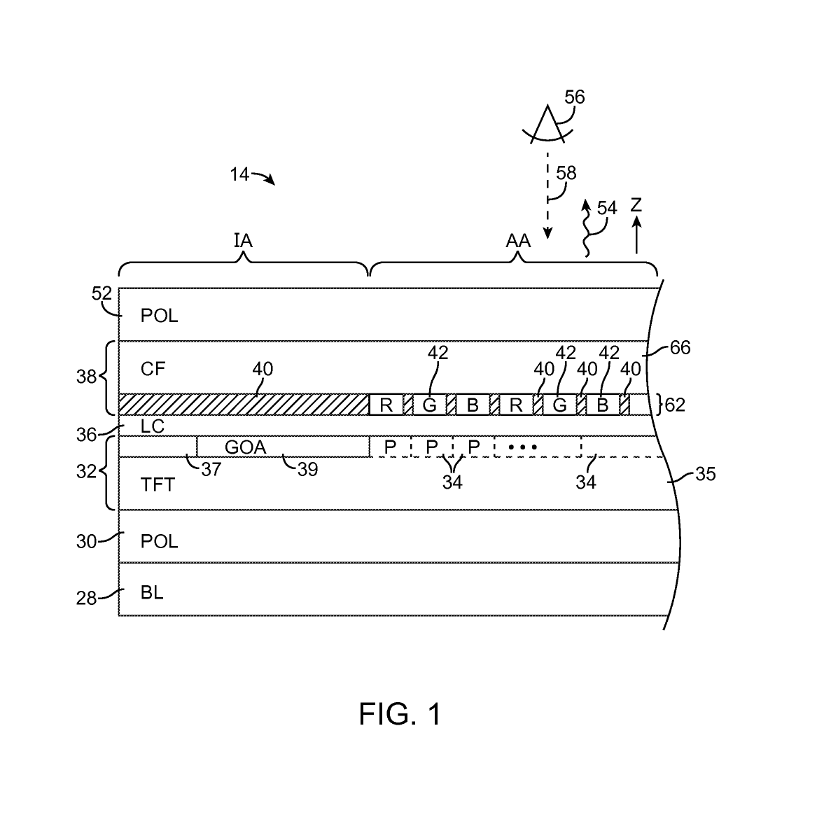

A display such as display 14 of FIG. 1 may be used in an electronic devices such as a computer, a computer that is integrated into a display such as a computer monitor, a laptop computer, a tablet computer, a somewhat smaller portable device such as a wrist-watch device, pendant device, or other wearable or miniature device, a cellular telephone, a media player, a tablet computer, a gaming device, a navigation device, a computer monitor, a television, or other electronic equipment. Displays such as display 14 may use liquid crystal display technology as shown in FIG. 1 or may use other display technologies (e.g., electrophoretic display technology, electrowetting display technology, organic light-emitting diode display technology, plasma display technology, etc.). The use of liquid crystal display components in implementing display 14 is merely illustrative.

Display 14 may be a touch screen that incorporates capacitive touch electrodes or other touch sensor components or may be a display that is not touch sensitive. Display 14 may be mounted in an electronic device housing. Electronic device housing structures in which display 14 may be mounted may be formed of plastic, glass, ceramics, fiber composites, metal (e.g., stainless steel, aluminum, etc.), other suitable materials, or a combination of any two or more of these materials. The housing may be formed using a unibody configuration in which some or all of the housing is machined or molded as a single structure or may be formed using multiple structures (e.g., an internal frame structure, one or more structures that form exterior housing surfaces, etc.).

Display 14 may have an inactive portion such as inactive portion IA that surrounds an active portion such as active portion AA. Active region AA may, for example, form a rectangular central portion of display 14 (when viewed in direction 58 by viewer 56) and may be surrounded by an inactive region IA with the shape of a rectangular ring. Display 14 may have other active area shapes and inactive area shapes, if desired. Configurations in which an inactive region IA extends along each of the four edges of a rectangular active region AA are described herein as an example.

As shown in FIG. 1, display 14 may have a layer of liquid crystal material such as liquid crystal material 36 that is sandwiched between display layers such as color filter layer 38 and thin-film transistor layer 32. Upper polarizer 52 may be formed above color filter layer 38. Lower polarizer 30 may be formed below thin-film transistor layer 32.

Thin-film transistor layer 32 may have an array of display pixels 34 (e.g., pixels P) in active area AA. Each display pixel may have a display pixel electrode for applying an electric field to a corresponding portion of liquid crystal layer 36. The display pixel electrodes may be controlled by thin-film transistor circuitry on thin-film transistor layer 32. For example, each display pixel P may contain a thin-film transistor having a gate that is coupled to a gate line. Thin-film transistors may also be used in forming gate driver circuitry 39 (sometimes referred to as gate on array circuitry or GOA circuitry). The gate driver circuitry may drive gate signals onto the gate lines. Additional structures 37 (e.g., metal traces) may run along the outer edge of gate driver circuitry 39.

Thin-film transistor layer 32 may have a substrate such as substrate 35. Substrate 35 may be a clear glass layer or a layer of other transparent material such as a layer of polymer. Thin-film transistor circuitry such as thin-film transistors, metal lines, patterned electrodes for display pixels 34, and other structures may be formed on substrate 35.

The thin-film transistor circuitry of thin-film transistor layer 32 may include amorphous silicon transistor circuitry or polysilicon transistor circuitry. Interconnect lines may be used to connect electrodes formed from conductive materials such as indium tin oxide and metal to thin-film structures such as thin-film transistors.

The electrodes in the thin-film transistor circuitry of thin-film-transistor layer 32 may be used to produce electric fields that control the orientation of liquid crystals in liquid crystal layer 36. Backlight unit 28 may be used to produce backlight 54 for display 14. Backlight 54 may pass through display 14 in vertical direction Z. This provides illumination for display 14 so that a user such as viewer 56 who is observing display 14 in direction 58 may clearly observe images that are produced by the display pixels in active area AA.

By controlling the orientation of the liquid crystals in layer 36, the polarization of backlight 54 may be controlled. In combination with the presence of polarizer layers 30 and 52, the ability to control the polarization of the light passing through individual pixels of liquid crystal material 36 provides display 14 with the ability to display images for viewer 56.

Backlight unit 28 may include a light source such as a light-emitting diode array for producing backlight 54. Polarizers such as polarizer 30 and polarizer 52 may be formed from thin polymer films.

If desired, display 14 may be provided with layers for reducing fingerprints (e.g., a smudge-resistant coating in a touch-sensitive display), anti-scratch coatings, an antireflection coating, a layer for reducing the impact of static electricity such as indium tin oxide electrostatic discharge protection layer, or other layers of material. The display layers that are used in the illustrative configuration of FIG. 1 are merely illustrative.

Display 14 may include a color filter layer such as color filter layer 38. Color filter layer 38 may include a color filter layer substrate such as substrate 66. Substrate 66 may be formed from a clear layer of material such as glass or plastic.

Color filter layer 38 may include an array of color filter elements 42 formed on substrate 66. Color filter elements 42 may include, for example, red elements R, green elements G, and blue elements B. The array of color filter elements in color filter layer 38 may be used to provide display 14 with the ability to display color images. Each of display pixels P in thin-film transistor layer 34 may be provided with a respective overlapping color filter element 42.

Adjacent color filter elements 42 may be separated by interposed portions of opaque masking material 40. Opaque masking material 40 may be formed from a dark substance such as a polymer that contains a black pigment. Opaque masking material 40 may therefore sometimes be referred to as a black mask, black masking layer, black pigmented layer, or black masking material. Illustrative polymeric materials for forming black masking layer 40 include acrylic-based and polyimide-based photoresists. An illustrative black pigment that may be used for black masking layer 40 is amorphous carbon (e.g., carbon black).

In active region AA, black mask 40 may be formed from a grid of relatively thin lines (sometimes referred to as a black matrix). The black matrix may have a pattern of openings such as an array of rectangular holes for receiving color filter elements. In inactive region IA, black masking material may be used in forming a peripheral black mask that serves as a black border for display 14. The black mask in inactive area IA may have a rectangular ring shape that surrounds a central rectangular active area AA (as an example).

Color filter elements 42 and black masking layer 40 may form layer 62 on the lower surface of substrate 66. Thin-film transistor layer 32 may include gate driver circuitry 39 for producing gate control signals (gate line voltage Vgl) for controlling thin-film transistors in display pixels 34. Gate driver circuitry 39 may be powered using a positive power supply voltage and a ground power supply voltage (as examples). Display pixels 34 may be provided with a common electrode signal (sometimes referred to as Vcom) using a blanket film of a transparent conductor such as indium tin oxide. Gate driver circuitry 39 may extend along the edge of the array of display pixels in active area AA. There may be, for example, a strip of gate driver circuitry 39 along the left and right edges of display 14.

During operation, gate driver circuitry 39 may apply gate driver signals Vgl to pixels 34. The black masking material and other structures in layer 62 are electrically floating. As a result, layer 62 may float to an unknown voltage such as 10 volts (as an example). Signals such as the Vgl signals used to control pixels 34 and associated signals in gate driver circuitry 39 e.g., a ground voltage Vss) may be maintained at voltages that differs from the floating voltage of layer 62. As an example, lines Vgl and Vss may have a voltage of about 0 volts (−10 volts relative to floating layer 62). Due to the voltage difference between the metal lines on thin-film-transistor layer 32 such as the Vss and Vgl lines in gate driver circuitry 39, there is a potential that gate driver circuitry 39 (e.g., the portion of the Vss and Vgl lines in gate driver circuitry 39) will produce electric fields that induce electric charge in layer 62 (e.g., in the black masking material in layer 62). This induced electric charge may, in turn, adversely affect the performance of display 14. For example, induced electric charge may cause display 14 to exhibit a greenish or purplish color cast.

To help avoid color artifacts such as these in display 14, one or more conductive electromagnetic shielding layers may be formed on display 14. For example, a shielding layer may be formed between layer 62 (e.g., the black masking layer on color filter 38) and metal lines on thin-film transistor layer 32 (e.g., the metal interconnects associated with gate driver circuitry 39 on thin-film-transistor layer 35).

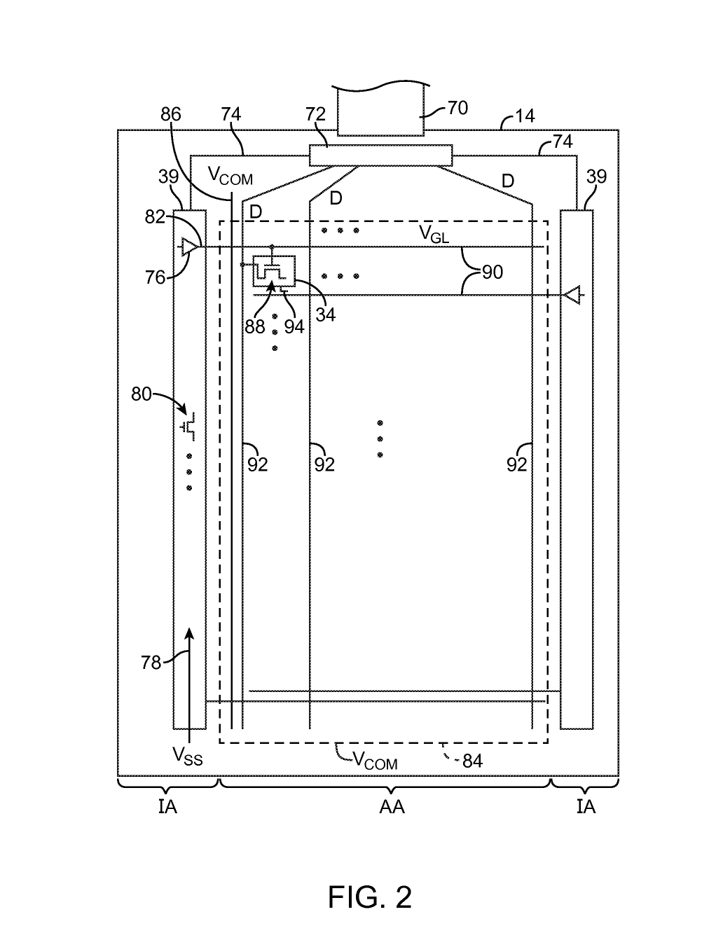

A top view of display 14 showing an illustrative configuration that may be used for implementing gate driver circuitry and other circuitry in display 14 is shown in FIG. 2. As shown in FIG. 2, display 14 may be coupled to cable 70. Display 14 may be provided with information to be displayed on display pixels 34 using cable 70. The content to be displayed on display 14 may include text, graphics, still images, and moving video. Control circuitry such as processing circuitry (e.g., a microprocessor, microcontroller, application-specific integrated circuit, or other processor) and storage (e.g., random-access memory, read-only memory, non-volatile memory, volatile memory, or other suitable storage may be used in providing content to display 14 via cable 70.

Display control circuitry 72 may receive the content that is to be displayed from cable 70. Display control circuitry 72 may be mounted on a ledge of thin-film transistor substrate layer 35 or other suitable portion of display 14. Display control circuitry 72 may be implemented using an integrated circuit (e.g., a display driver integrated circuit) and/or additional circuits (e.g., thin-film circuitry and/or circuitry that is external to display 14).

Display control circuitry 72 may provide gate driver circuitry 39 with control signals such as clock signals on paths 74. Gate driver circuitry 39 may include thin-film transistor circuitry such as thin-film transistor 80. Gate line drivers 76 may be used to control gate line voltages Vgl on data lines 90. Each gate driver circuit 39 may include thin-film transistors such as thin-film transistor 80 and conductive lines such as portions (segments) 82 of gate lines 90 and power supply lines such as ground power supply line 78 (as examples).

Active area AA of display 14 may include an array of vertical lines such as data lines 92 (carrying data signals D) and an array of horizontal lines such as gate lines 90 (carrying gate line signals Vgl). An array of display pixels 34 may be controlled using signals on data lines 92 and gate lines 90. Each display pixel may, as an example, include a thin-film transistor such as transistor 88. When an associated gate line 90 is taken high, transistors such as transistor 88 in that row of the array will be turned on and will pass a corresponding data signal D to an associated display pixel electrode, thereby applying an electric field that is proportional to data signal D to a pixel-sized region of liquid crystal layer 36.

A blanket region of transparent conductive material such as a rectangular indium tin oxide layer may be used to form common electrode 84. Common electrode 84 may carry voltage Vcom for pixels 34 (e.g., to pixel terminals such as pixel terminal 94) and may sometimes be referred to as a Vcom electrode. Conductive lines (e.g., metal lines) such as line 86 may be used to carry voltages to common electrode 84 such as voltage Vcom. In some configurations for display 14, there may be multiple Vcom values (e.g., Vcom1 and Vcom2) and multiple corresponding Vcom electrodes separated by one or more gaps. In the arrangement of FIG. 2, display 14 has a single common electrode 84 that is provided with a single Vcom voltage using Vcom line 86.

Conductive lines such as gate lines 82, power supply lines 78, and common electrode line 86 may be electromagnetically shielded using conductive shield layer structures. The shield layer structures may prevent electric fields from the conductive lines from inducing charge in layer 62 that might produce color artifacts in display 14. The shield layer structures may, if desired, be shorted to conductive line structures in display 14. As an example, a shield layer may be electrically connected to a Vcom line such as line 86. Other conductive lines may also be shorted to shield layer structures if desired. Shield layers may also be electrically isolated from conductive lines.

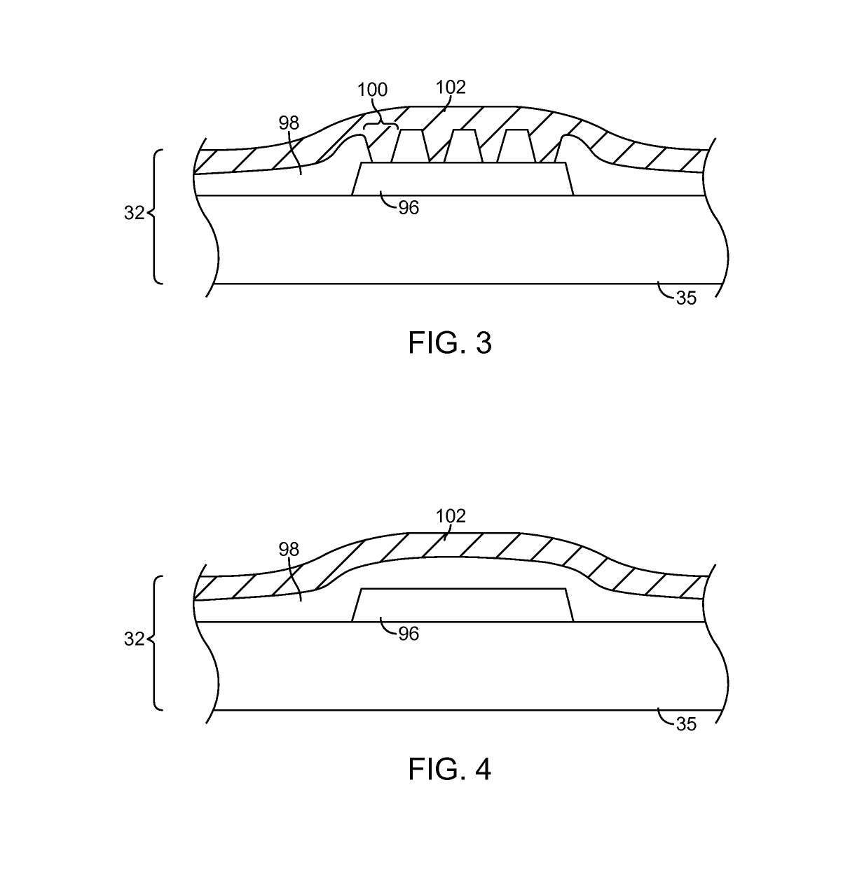

An illustrative shield layer structures is shown in FIG. 3. As shown in FIG. 3, thin-film-transistor layer 32 may include a substrate such as thin-film-transistor layer substrate 35. Conductive lines such as conductive line 96 may be formed on substrate 35 (directly on the surface of substrate 35 or on top of an interposed dielectric layer). Line 96 may be a power supply line (e.g., a power supply line in gate driver circuitry 39 such as power supply line 78 of FIG. 2), a Vcom line such as line 86 of FIG. 2, a portion of a gate line such as gate line 82 of FIG. 2, or other conductive lines in display 14. Dielectric (insulating) layer 98 may be formed on top of conductive line 96 (e.g., so that layer 98 completely overlaps line 96 as shown in FIG. 3). Layer 98 may also overlap other structures on substrate 35 (e.g., thin-film transistors, conductive lines, etc.). Examples of materials that may be used in forming layer 98 include silicon nitride, silicon oxide, other oxides, other nitrides, oxynitrides, and polymers.

Conductive shielding layer 102, which may be, for example, part of a Vcom electrode such as electrode 84 of FIG. 2, may be formed on insulating layer 98. Conductive shielding layer 102 may be formed from a transparent conductive material such as indium tin oxide or other conductive materials (e.g., metal). If desired, insulating layer 98 may be provided with one or more openings such as vias 100 to allow conductive shield layer 102 to be electrically connected to conductive line 96. Layer 98 may also be free of openings 100 over line 96, as illustrated in the cross-sectional view of line 96 in FIG. 4.

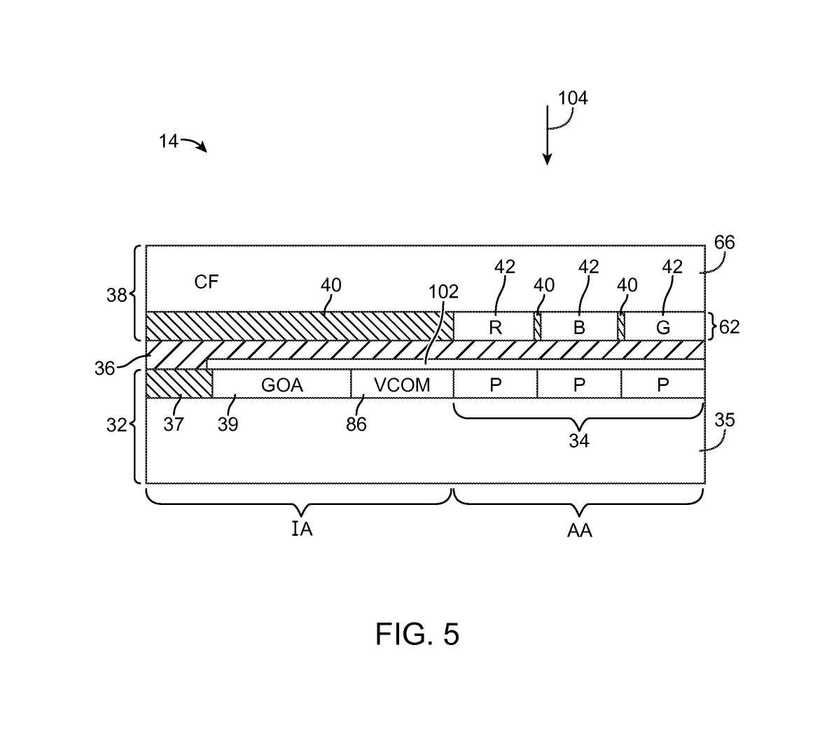

As shown in the cross-sectional side view of display 14 of FIG. 5, shielding layer 102 may be formed using an extended portion of a Vcom electrode (e.g., an indium tin oxide electrode) or other conductive structure that overlaps display pixels 34. Shielding layer 102 may also extend across the entire width of line 86, so that line 86 does not produce electric fields that induce charge in layer 62.

An insulating layer such as insulating layer 98 of FIG. 3 may be formed under shielding layer 102. Vias such as vias 100 of FIG. 3 may allow line 86 to electrically connect to shield layer 102. Shield layer 102 may, if desired, overlap gate driver circuitry 39 (e.g., to cover and thereby shield gate lines 82 and/or power supply lines 78). Shield layer 102 need not extend over additional structures 37 (in this example), because structures 37 are not sufficiently close to display pixels 34 to produce color artifacts in active area AA.

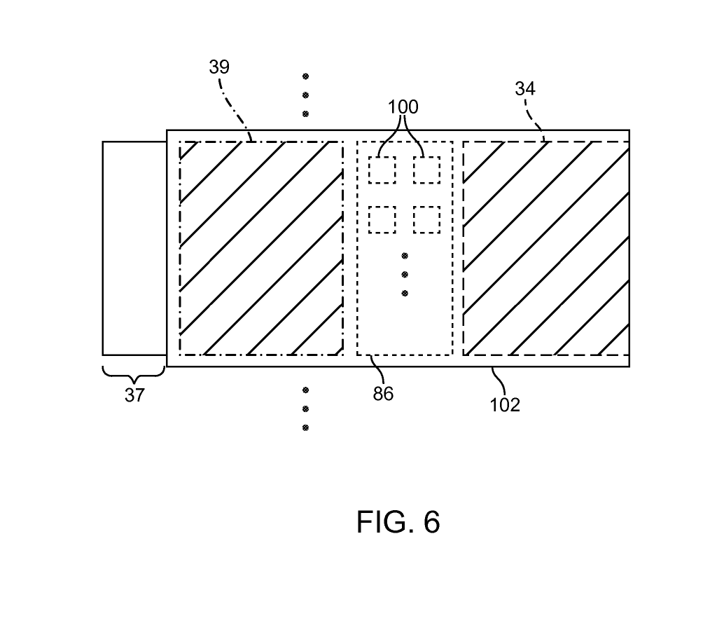

FIG. 6 is a top view of display 14 of FIG. 5 when viewed in direction 104 of FIG. 5. As shown in FIG. 6, vias such as vias 100 may be formed in insulating layer 98 to allow shielding layer 102 to be electrically shorted to line 86.

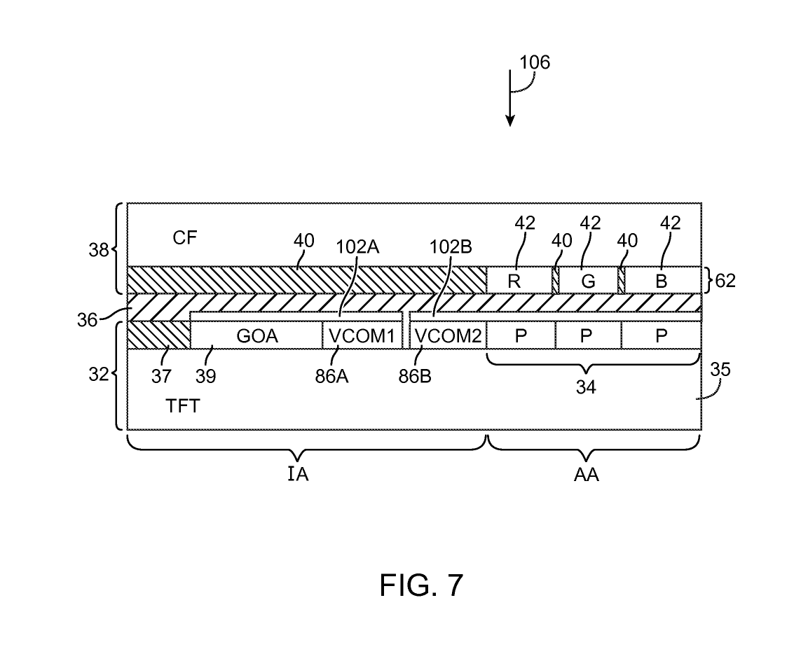

In some configurations, display 14 may have conductive structures that distribute multiple common electrode voltages. For example, display 14 may have a first common electrode that is maintained at a first Vcom voltage of Vcom1 and may have a second common electrode that is maintained independently at a second Vcom voltage of Vcom2. This type of arrangement is shown in FIG. 7. As shown in FIG. 7, common electrode line 86 in this type of configuration may be divided into multiple conductive lines such as lines 86A and 86B. Conductive line 86A may be used to carry voltage Vcom1 and may be shorted to first shield layer 102A (e.g., using vias such as vias 100 that pass through an insulating layer such as insulating layer 98 of FIG. 3 that is formed under shield layer 102A). Conductive line 86B may be used to carry voltage Vcom2 and may be shorted to second shield layer 102B (e.g., using vias such as vias 100 that pass through an insulating layer such as insulating layer 98 of FIG. 3 that is formed under shield layer 102A).

Shield layers 102A and 102B may be formed from indium tin oxide or other conductive materials. Conductive lines such as lines 86, 86A, and 86B may be formed from metal, indium tin oxide, or other conductive materials. During operation of display 14, Vcom1 may vary as a function of time and may not always be held at 0 volts (or other ground voltage). Vcom2 may be held at a low direct-current-like voltage and may be varied as a function of time to ensure that the magnitude of the voltage difference between Vgl and Vcom2 is less than the damage threshold for the thin-film transistors in gate driver circuitry 39.

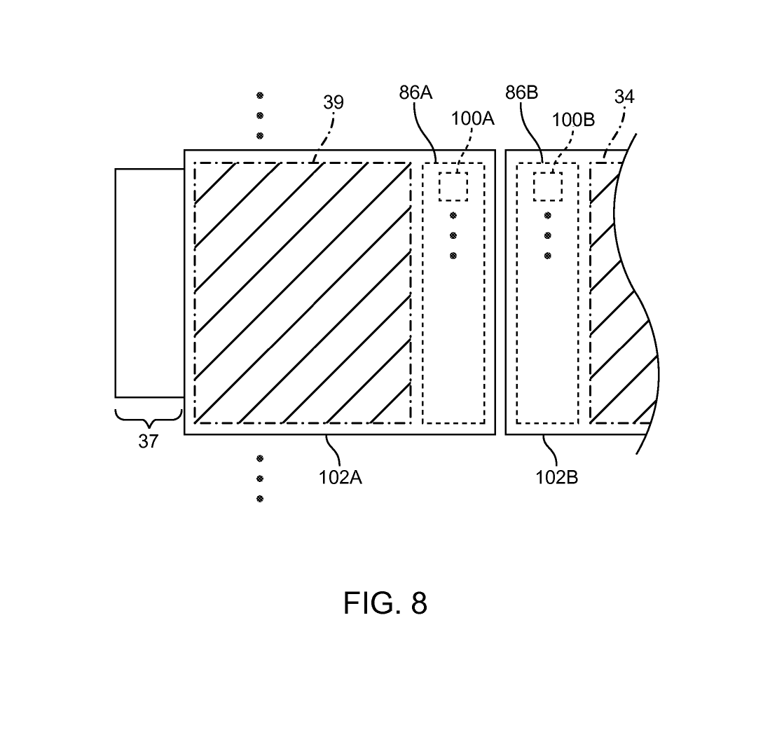

FIG. 8 is a top view of display 14 of FIG. 7 when viewed in direction 106 of FIG. 7. As shown in FIG. 8, vias such as vias 100A may be formed in insulating layer 98 to allow shielding layer 102A to be electrically shorted to common electrode metal line 86A. Vias such as vias 100B may be formed in insulating layer 98 to allow shielding layer 102B to be electrically shorted to common electrode metal line 86B.

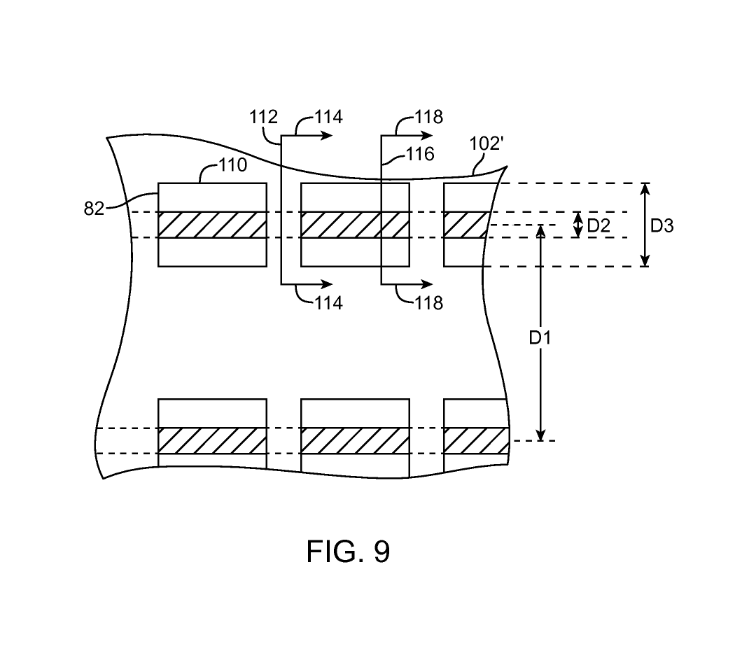

The presence of a conductive shield layer over the conductive lines of display 14 may give rise to capacitive coupling between the conductive shield layer and the conductive lines. As an example, shield layers 102, 102A, and 102B may overlap gate lines on display 14, leading to capacitive loading effects that have the potential to slow gate line signal rise times. To reduce capacitive loading effects due to the overlap of the conductive shield layer, the conductive shield layer may be provided with openings such as openings 110 in illustrative conductive shield layer 102′ of FIG. 9. Shield layer 102′ may be formed from indium tin oxide or other conductive materials and may be used as shield layer 102 in a configuration of the type shown in FIGS. 5 and 6 or may be used as shield layers 102A and/or 102B in a configuration of the type shown in FIGS. 7 and 8.

As shown in FIG. 9, openings 110 in shield layer 102′ may be arranged in an array so that shield layer 102′ forms a conductive mesh. Openings 110 may each have a rectangular shape as shown in FIG. 9 or may have other suitable shapes (e.g., shapes with straight edges, shapes with curved edges, shapes with a combination of curved and straight edges, etc.).

Openings 110 may be configured so that rows (or columns) of openings 110 overlap conductive metal lines on thin-film transistor substrate 35 such as gate lines (gate line segments) 82. With this type of arrangement, the amount of conductive material in shielding layer 102′ that overlaps each gate line 82 or other metal line on thin-film-transistor substrate 35 may be reduced. The mesh pattern of shield layer 102′ may extend over substantially all of the area of gate driver circuitry 39 and Vcom line 86 as shown by shield layer 102 in the top view of FIG. 6. In a configuration of the type shown in FIG. 8, the mesh pattern of shield layer 102′ may extend over substantially all of the area of gate driver circuitry 39′ and Vcom1 line 86A, as shown by shielding layer 102A of FIG. 8 and may extend over substantially all of Vcom2 line 86B, as shown by shielding layer 102B of FIG. 8. The portion of the shield layer that overlaps display pixels 34 may be solid.

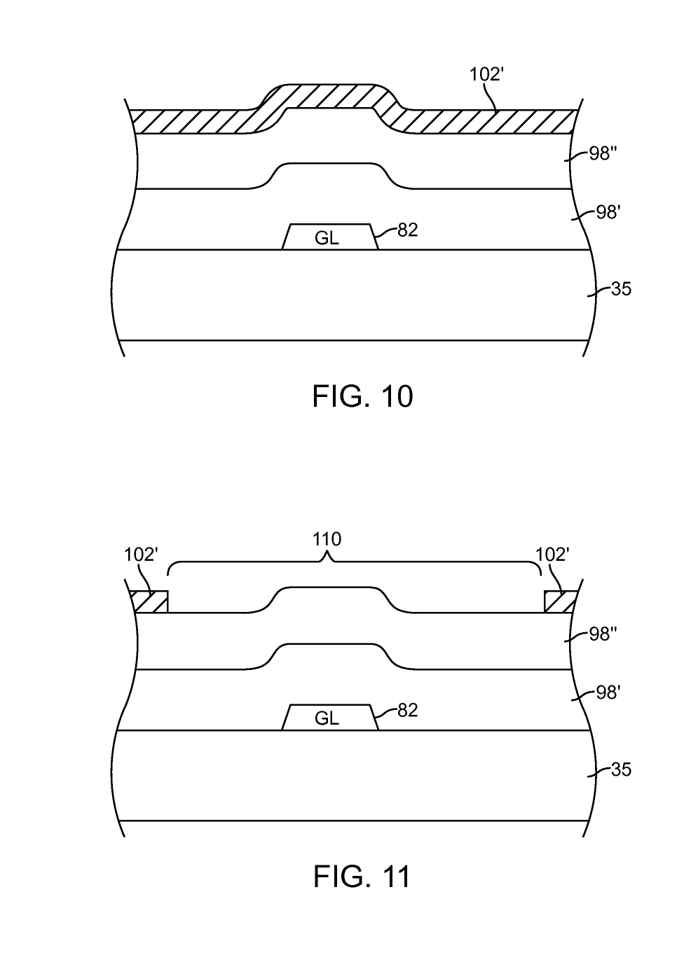

A cross-sectional side view of gate line 82 and the other display structures of FIG. 9 taken along line 112 of FIG. 9 and viewed in direction 114 is shown in FIG. 10. As shown in FIG. 10, this portion of gate line 82 may be covered by an overlapping portion of shielding layer 102′.

Insulating material such as insulating layers 98′ and 98″ may be interposed between gate line 82 and conductive shield layer 102′ to help electromagnetically shield the material of layer 62 in color filter 38.

A cross-sectional side view of gate line 82 and the other display structures of FIG. 9 taken along line 116 of FIG. 9 and viewed in direction 118 is shown in FIG. 11. As shown in FIG. 11, this portion of gate line 82 may be left uncovered by shielding layer material and may therefore be free of any overlapping portions of layer 102′. Insulating material such as insulating layers 98′ and 98″ may overlap gate line 82 as in FIG. 10, but layer 102′ is absent in the region above gate line 82 due to the presence of opening 110.

The size and shapes of the optional mesh openings in the conductive shielding layer may be selected to balance shielding efficacy with minimized gate line capacitive loading. With one illustrative configuration, lines 82 may have a center-to-center spacing D1 of about 100 microns (e.g., 50-200 microns), lines 82 may have a line width of about 1 micron (e.g., 0.5 to 2 microns), and openings 110 may have lateral dimensions D3 of about 20-50 microns, 10-100 microns, 5-200 microns, or other suitable size. These dimensions are merely illustrative. If desired, lines 82 and openings 110 may have other shapes and sizes.

The foregoing is merely illustrative of the principles of this invention and various modifications can be made by those skilled in the art without departing from the scope and spirit of the invention.

What is claimed is:

1. A display, comprising:
a color filter layer;
a thin-film transistor layer;
a liquid crystal layer between the color filer layer and the thin-film transistor layer, wherein the thin-film transistor layer has an array of display pixels controlled by data lines and gate lines and has gate driver circuitry that provides gate signals to the gate lines; and
a conductive shield layer that covers the gate driver circuitry to shield the color filter layer from electric fields produced by the gate driver circuitry.

2. The display defined in claim 1 wherein the conductive shield layer comprises a layer of indium tin oxide.

3. The display defined in claim 2 wherein the layer of indium tin oxide covers the display pixels

4. The display defined in claim 2 wherein the conductive shield layer comprises at least separate first and second portions that are separated by a gap and wherein the first portion covers the display pixels and wherein the second portion covers the gate driver circuitry.

5. The display defined in claim 1 wherein the conductive shield layer has an array of openings, wherein the gate lines comprise metal gate line segments, and wherein at least some of the openings in the array of openings overlap the metal gate line segments.

6. The display defined in claim 5 wherein the conductive shield layer comprises an indium tin oxide layer in which the array of openings is formed.

7. The display defined in claim 1 wherein the gate driver circuitry includes at least one ground power supply line and wherein the conductive shield layer covers the ground power supply line.

8. The display defined in claim 7 wherein the gate driver circuitry includes segments of the gate lines and wherein the conductive shield covers the segments of the gate lines.

9. The display defined in claim 8 further comprising a metal common electrode line on the thin-film-transistor layer, wherein the metal common electrode line has a width and wherein the conductive shield layer extends across the width of the metal common electrode line.

10. A display, comprising:
a color filter layer;
a liquid crystal layer; and
a thin-film-transistor layer, wherein the thin-film transistor layer has an array of display pixels and has thin-film transistors that form gate driver circuitry, the thin-film-transistor layer further comprising an indium tin oxide shielding layer that covers the gate driver circuitry and that covers the array of display pixels.

11. The display defined in claim 10 wherein the thin-film-transistor layer further comprises a metal common electrode line that runs along an edge of the array of display pixels, wherein the metal common electrode line has a width, and wherein the indium tin oxide shielding layer extends across the width of the metal common electrode line and covers that metal common electrode line.

12. The display defined in claim 11 further comprising gate lines and data lines on the thin-film-transistor layer, wherein the gate driver circuitry includes segments of the gate lines and wherein the segments of the gate lines are covered by the indium tin oxide shielding layer.

13. The display defined in claim 12 further comprising openings in the indium tin oxide layer that overlap the segments of the gate lines.

14. The display defined in claim 10 wherein the thin-film-transistor layer has gate lines and data lines for controlling the display pixels, wherein the gate driver circuitry provides gate line signals on the gate lines and includes thin-film transistors that are covered by the indium tin oxide shielding layer.

15. The display defined in claim 14 wherein the thin-film-transistor layer further comprises a metal common electrode line and an insulating layer with openings that overlap the metal common electrode line, wherein the indium tin oxide layer is shorted to the metal common electrode line through the openings.

16. A display, comprising:
a color filter layer;
a liquid crystal layer; and
a thin-film-transistor layer, wherein the thin-film transistor layer has an array of display pixels and has thin-film transistors that form gate driver circuitry, the thin-film-transistor layer further comprising at least a first indium tin oxide shielding layer that covers the display pixels and a second indium tin oxide shielding layer that is separate from the first indium tin oxide shielding layer and that covers the gate driver circuitry.

17. The display defined in claim 16 wherein the thin-film-transistor layer further comprises first and second metal common electrode lines that run along an edge of the array of display pixels, wherein the first indium tin oxide shielding layer covers the first metal common electrode line, and wherein the second indium tin oxide shielding layer covers the second metal common electrode line.

18. The display defined in claim 17 further comprising a layer of insulating material, wherein the first and second indium tin oxide shielding layers are formed on the layer of insulating material.

19. The display defined in claim 18 wherein the layer of insulating material has openings through which the first indium tin oxide shielding layer contacts the first metal common electrode line.

20. The display defined in claim 19 wherein the layer of insulating material has additional openings through which the second indium tin oxide shielding layer contacts the second metal common electrode line.
